(19) United States
(12) Patent Application Publication
(10) Pub. No.: US 2026/0362478 A1
(43) Pub. Date: Nov. 12, 2026

(54) DYNAMIC TIME ALLOCATION FOR VIRTUAL SIMULTANEOUS DUAL BAND OPERATIONS

(71) Applicant: Cypress Semiconductor Corporation, San Jose, CA (US)

(72) Inventors: Suresh Sanaboina, West Godavari (IN); Vinoth Sampath, Bangalore (IN); Manish Bansal, Bangalore (IN); Chaitra Chowdappa, Bangalore (IN); Sri Ramya Thota, Bangalore (IN)

(73) Assignee: Cypress Semiconductor Corporation, San Jose, CA (US)

(21) Appl. No.: 19/203,468

(22) Filed: May 9, 2025

(51) Int. Cl. H04W 74/04; H04W 74/0833; H04W 80/02

(52) U.S. Cl. CPC H04W 74/04; H04W 74/085; H04W 80/02

(57) ABSTRACT

Technologies directed to dynamic time allocation between different bands operated using a virtual simultaneous dual band (VSDB) approach is described. A method of operating a wireless device with a single media access control (MAC) layer, including operating a first access point (AP) within a first band and a second AP within a second band according to a first time division multiplexing (TDM) schedule. The first TDM schedule allocates a first time-interval to the first AP and a second time-interval to the second AP. Responsive to determining that the first AP is to perform a network management operation, operating the first and second APs according to a second TDM schedule. The second TDM schedule allocates a third time-interval having a duration longer than the first time-interval to the first AP.

### BACKGROUND

In automotive environments, infotainment is popularly used for connecting and coordinating multiple peers for variety of devices and applications. In these environments, concurrency roles with good performance metrics are desired and may typically only be achieved by dedicated wireless local area network (WLAN) (Radio/PHY/MAC) devices such as real simultaneous dual band (RSDB) which may be costly and not affordable to some customers.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a wireless device with virtual simultaneous dual band (VSDB) logic, according to one embodiment.

FIG. 2 is a timing diagram illustrating the VSDB logic operating multiple APs within a single target beacon transmission time (TBTT) interval, according to one embodiment.

FIG. 3 is a flowchart illustrating a method of operating multiple APs within a single TBTT interval, according to one embodiment.

FIG. 4 is a timing diagram illustrating the VSDB logic operating multiple APs within a single TBTT interval according to asymmetrical time slices, according to one embodiment.

FIG. 5 is a flowchart illustrating a method of operating multiple APs within a single TBTT interval according to asymmetrical time slices, according to one embodiment.

FIG. 6 is a timing diagram illustrating the VSDB logic modifying time slices, according to one embodiment.

FIG. 7 illustrates a communication system including a client device and a wireless device, according to one embodiment.

FIG. 8 is a flowchart illustrating a method of performing a WLAN onboarding process, according to one embodiment.

FIG. 9 is a flowchart illustrating a method of performing a dynamic host configuration protocol (DHCP) discovery and onboarding process, according to one embodiment.

FIG. 10 is a timing diagram illustrating the VSDB logic operating multiple active APs within same frequency bands during TBTT intervals, according to one embodiment.

FIG. 11 is a flowchart illustrating a method of operating multiple active APs within same frequency bands during TBTT intervals, according to one embodiment.

FIG. 12 a flowchart illustrating a method of modifying time slices (also referred to as time-intervals), according to one embodiment.

FIG. 13 a flowchart illustrating a method of operating multiple APs within a same band, according to one embodiment.

FIG. 14 a flowchart illustrating a method of operating multiple APs according to an asymmetrical time division multiplexing (TDM) schedule, according to one embodiment.

### DETAILED DESCRIPTION

Technologies directed to dynamic time allocation between different bands operated using a virtual simultaneous dual band (VSDB) approach is described. In real-time simultaneous dual-band (RSDB) applications, wireless devices are designed to operate concurrently on multiple frequency bands—e.g., the 2.4 GHz and 5 GHz bands—to enhance network performance and data throughput. RSDB achieves true simultaneous dual-band operation by incorporating two separate MAC (Media Access Control) and PHY (Physical Layer) components within the device, each dedicated to one frequency band. Each MAC/PHY pair is equipped with its own physical coordination function (CF) timer, which is used to maintain timing and synchronization. These individual CF timers drive the Timing Synchronization Function (TSF) of their respective access points (APs), enabling each AP to operate independently on different bands while maintaining synchronization across the network. This architecture allows for simultaneous communication on both bands without interference, thereby improving network efficiency and reducing latency in wireless communications.

In wireless devices that lack two separate MAC/PHY pairs, driving the TSFs of two different APs is conventionally impossible using a single coordination function (CF) timer. A single CF timer cannot simultaneously synchronize multiple TSFs operating on different frequency bands because it can only maintain timing for one frequency band at a time. In these situations, Virtual Simultaneous Dual Band (VSDB) technology may be utilized to allow different APs or Stations (STAs) to share a single MAC/PHY pair in a time-division multiplexing fashion. In general, VSDB applications enable devices to switch rapidly between APs or STAs (or frequency bands), allocating specific time slots to each AP or STA. By alternating between APs or STAs in a controlled sequence, VSDB applications can create the appearance of simultaneous dual-band operation using only one MAC/PHY pair (although the operations of the different APs or STAs are not truly simultaneous). This approach allows for dual-band connectivity without the need for duplicate hardware components.

However, VSDB applications pose various challenges. For example, onboarding processes can be delayed or cut short by static time divisions in VSDB applications. Since conventional VSDB applications operate on a fixed schedule (or fixed time allocation) for switching between APs or STAs, onboarding may not be available on a particular AP when a new device attempts to connect or authenticate. This can lead to increased latency in the onboarding process, as the new device must wait until the shared MAC/PHY pair returns to the desired band. Additionally, the time allocated to each AP or STA may be insufficient to complete the onboarding process within a single time slot, causing further delays and/or timeouts (e.g., onboarding failure).

Additionally, in conventional VSDB applications, implementing Multiple Basic Service Sets (MBSS)—such as providing both a primary network and a guest network—can be particularly challenging due to the inherent limitations of the VSDB architecture. Since VSDB relies on a single MAC/PHY pair that alternates between frequency bands in a time-division multiplexing manner, it cannot sustain simultaneous communication across multiple networks. MBSS requires the access point (AP) to manage multiple BSSIDs concurrently, allowing clients to connect to either the primary or guest network (or networks of any other MBSS application) without interruption. However, in a VSDB setup, the shared MAC/PHY resources must divide their operational time between the different networks, leading to increased latency, potential connection delays, and reduced throughput.

Furthermore, obtaining good performance metrics for latency-sensitive products is challenging when using conventional VSDB applications. The inherent time-division multiplexing introduces additional latency because the device cannot continuously communicate on both bands. Applications that require real-time data transmission, such as voice over IP, online gaming, or live video streaming, may suffer from increased latency, jitter, and packet loss. The periodic unavailability of the device on a particular band can disrupt the steady flow of data, making it difficult to meet the stringent performance requirements of latency-sensitive applications.

Aspects and Embodiments of the present disclosure address the problems and challenges addressed above and others by providing an improved VSDB application with dynamic time allocation. This dynamic time allocation may be performed by referencing a CF timer generated by a single MAC/PHY pair. Aspects and embodiments of the present disclosure may modify a schedule for switching between APs or STAs to handle certain time-consuming and/or critical operations of an AP or STA, such as scans for connection initiation, dynamic host configuration protocol (DHCP) discovery, device onboarding, or other network management operations. This schedule may include time slices (also referred to as time-intervals) that each allocate a segment of a target beacon transmission time (TBTT) interval to respective active APs. Aspects and embodiments of the present disclosure may enable MBSS applications (e.g., concurrent main and secondary networks within same band) by applying dynamic time slicing via multiple CF timer references. Aspects and embodiments of the present disclosure may provide a dynamic time slicing approach that allocates greater medium times to an AP or STA that supports latency sensitive applications.

Aspects and embodiments of the present disclosure may include operating a first access point (AP) within a first band and a second AP within a second band according to a first time division multiplexing (TDM) schedule. This first TDM schedule may allocate a first time-interval to the first AP and a second time-interval to the second AP. Thereafter, it may be determined that the first AP is to perform a critical operation such as onboarding a new connection, DHCP process or any other operations which have been pre-determined as being critical or priority for example in the VSDB application. Then, based on the determination that the first AP is to perform the network management operation, the first and second APs may be operated according to a second TDM schedule. The second TDM schedule may allocate a third time-interval having a duration longer than the first time-interval to the first AP. The second TDM may allocate a fourth time-interval having a duration shorter than the second time-interval to the second AP.

Aspects and embodiments of the present disclosure may include operating a first AP (e.g., primary network) and within a first band according to a TDM schedule. A first offset value may be determined based on the TDM schedule. A second AP (e.g., secondary network, or guest network) may be operated within the second band according to the TDM schedule and the offset value. The offset value may be software-defined. The offset value may reference a first time that a wireless device is to switch from the first AP to the second AP.

Aspects and embodiments of the present disclosure may include operating a first AP over a first sub-interval of a target beacon transmission time (TBTT). A second AP may be operated over a second sub-interval of the TBTT. The first and second sub-intervals may not overlap. A first duration of the first sub-interval may be greater than a second duration of the second sub-interval.

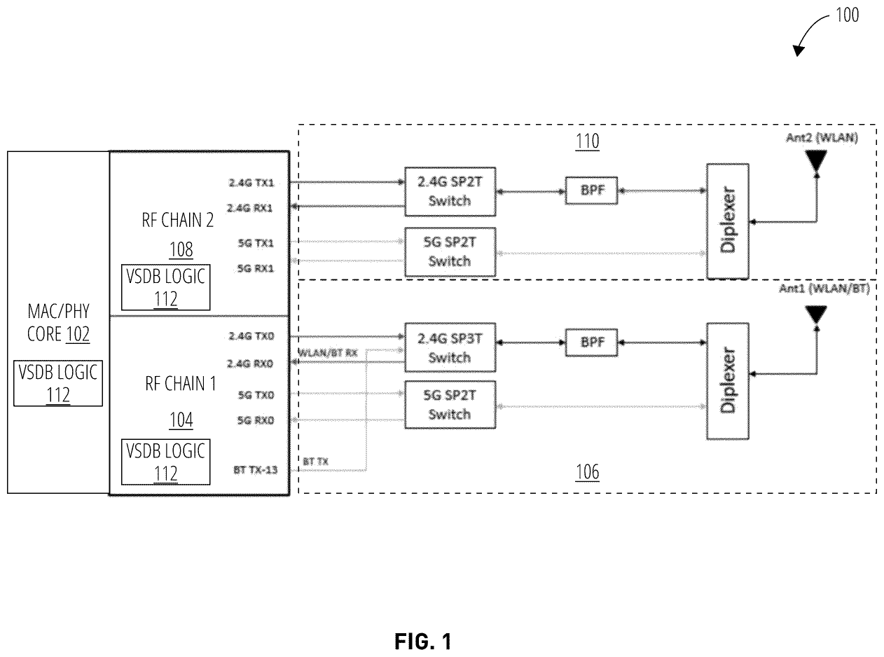

FIG. 1 illustrates a wireless device 100 with virtual simultaneous dual band (VSDB) logic 112, according to one embodiment. In at least one embodiment, the wireless device 100 may be a virtual single data band chip that only has one media access control (MAC) and physical layer (PHY) unit (here, the MAC/PHY core 102) that controls all transmissions of the wireless device 100. The wireless device 100 may include a first RF chain 104 and a second RF chain 108, both connected to the MAC/PHY core 102. In at least one embodiment, the wireless device 100 may not be capable of real simultaneous dual band (RSDB) operations, where two or more access points (APs) are operated simultaneously in real time. Instead, the wireless device 100 may be capable of VSDB, where two or more APs may be operated in a time division multiplexing (TDM) technique that mimics RSDB, albeit at worse performance metrics. This is because the TDM techniques cause a wireless device, such as the wireless device 100, to alternate its communication between different frequency bands or APs rather than accessing them simultaneously in real time.

In some embodiments, the first RF chain 104 may be enabled for one or more of Wireless Local Area Network (WLAN) and Bluetooth Low Energy (BLE) or Bluetooth (BT) communication. The first RF chain 104 may function as part of a TX/RX chain 106, related to the 802.11n spatial streams, where the first RF chain 104 may manage the encoding, modulation, and/or transmission of data over a network. In at least some embodiments, this first RF chain 104 may include a baseband processor and handle some signal processing tasks such as channel estimation, equalization, and interference mitigation. The first RF chain 104 may be coupled to a first transmit/receive (TX/RX) chain 106. This TX/RX chain 106 may include a 2.4 GHz single-pole triple-throw (SP3T) switch or, in alternative configurations, a single-pole double-throw (SP2T) switch (or other type of suitable switch or selection mechanism) to select the desired frequency band. The first TX/RX chain 106 may also include a 5 GHz SP2T switch, one or more bandpass filters (BPFs), a diplexer for combining or splitting signals of different frequency bands, and one or more antennas. In some embodiments, the antenna could be a single wideband antenna covering both 2.4 GHz and 5 GHz bands, or separate antennas dedicated to each band. This configuration allows the first RF chain 104 to operate in either the 2.4 GHz or 5 GHz frequency bands, facilitating communication over WLAN and BLE/BT protocols. While the first TX/RX chain 106 illustrated has a particular construction, one of skill in the art will appreciate that any suitable construction of a TX chain and RX chain, separated or combined, may be used in relation to the present disclosure. The flexibility in the TX/RX chain constructions and component selections allows manufacturers to optimize the wireless device 100 for cost, performance, size, or power consumption, depending on the application.

The second RF chain 108 may be enabled for WLAN communication and may be coupled to a second TX/RX chain 110. The second RF chain 108 may function as part of the TX/RX chain 110, related to the 802.11n spatial streams, where the second RF chain 108 may manage the encoding, modulation, and/or transmission of data over a network. In at least some embodiments, this second RF chain 108 may include a baseband processor and handle some signal processing tasks such as channel estimation, equalization, and interference mitigation. Similar to the first TX/RX chain 106, the second TX/RX chain 110 may include a 2.4 GHz SP3T switch or alternatively utilize an SP2T switch with additional filtering components. It also includes a 5 GHz Sp2T switch, a diplexer, and one or more antennas. In alternative embodiments, the TX/RX chain 110 might incorporate different switch types, such as single-pole single-throw (SPST) switches, or utilize duplexers instead of diplexers to manage signal paths. This setup may enable the second RF chain 108 to operate in both the 2.4 GHz and 5 GHz frequency bands exclusively for WLAN communication. Similar to the first TX/RX chain 106, while the second TX/RX chain 110 illustrated has a particular construction, one of skill in the art will appreciate that any suitable construction of a TX chain and RX chain, separated or combined, may be used in relation to the present disclosure. The flexibility in the TX/RX chain constructions and component selections allows manufacturers to optimize the wireless device 100 for cost, performance, size, or power consumption, depending on the application.

According to embodiments, the first RF chain 104 and second RF chain 108 may share the single MAC/PHY core 102 in a time division multiplexing (TDM) manner. The aspects and embodiments of the present disclosure described herein are equally applicable to other embodiments (not shown) where there may only be one RF chain or more than 2 RF chains (i.e., multiple-in, multiple-out (MIMO)). The embodiment in FIG. 1 may be configured in a MIMO arrangement where the RF chains 104, 108 may be concurrently used by the currently utilized frequency band or access point (AP) (e.g., 5 GHz, 2.4 GHz). For example, a 5 GHz AP may use RF chains 104, 108 during a first time-interval and a 2.4 GHz AP may use RF chains 104, 108 during a second time-interval. The TDM approach may enable the wireless device 100 to support VSDB operations, even though it is not capable of RSDB. In at least some embodiments, the wireless device 100 may perform VSDB operations based on VSDB logic 112. The VSDB logic 112 may include different logic operations of the wireless device 100, including but not limited to operations of one or more of the first RF chain 104, the second RF chain 108, or the MAC/PHY core 102. In at least some embodiments, the VSDB logic 112 may be optimized using different timing schedules, algorithms, or protocols to enhance performance based on specific application requirements.

While the wireless device 100 as illustrated in FIG. 1 has a particular construction, features of the present disclosure, such as operations of the VSDB logic 112 as described herein, may be implemented within any wireless device capable of performing VSDB operations. This includes, but is not limited to, chipsets of wireless devices that include multiple RF chains that share a MAC/PHY core. In some embodiments, the wireless device 100 might also include additional processing units or RF chains to handle other wireless communication standards such as Zigbee or LTE, provided they also share the MAC/PHY core 102 in a TDM manner. In alternative embodiments, the first RF chain 104 may handle one or more of these other wireless communication standards.

According to embodiments, the VSDB logic 112 may perform operations that allow multiple APs to be operated concurrently based on VSDB techniques described herein. The VSDB logic 112 may cause APs to share time within a target beacon transmission time (TBTT) interval. These TBTT intervals may refer to a regular, recurring duration between each scheduled TBTT. In at least some embodiments, the TBTT interval may be approximately 100 milliseconds (ms). In one embodiment, the TBTT interval may be 102.4 ms, which is 100 time units (TU). In other embodiments, the TBTT may be a different time-interval based on network design or performance goals.

In some embodiments, the time shared between the multiple APs is determined based on multiple factors, including minimizing network inefficiencies and maximizing resource utilization. Frequent switching between APs could lead to network inefficiencies and disruptions in client connectivity, while failing to switch between APs enough may result in failing to fully capitalize on available AP resources.

Because the wireless device 100 has a single MAC/PHY core 102, the VSDB logic 112 may only have access to a single coordination function (CF) hardware (HW) timer. Conventionally, both the first RF chain 104 and the second RF chain 108 must share this single CF HW timer when coordinating their wireless communications. However, aspects and embodiments of the present disclosure provide an improved VSDB approach that allows the VSDB logic 112 to generate one or more software-defined (SW) offsets and timers based on the CF HW timer. In at least some embodiments, these SW offsets and times may be stored within the MAC portion of the MAC/PHY core 102. The VSDB logic 112 may use these SW offsets and/or timers to control timing of one or more APs. This is described in more detail within the present disclosure.

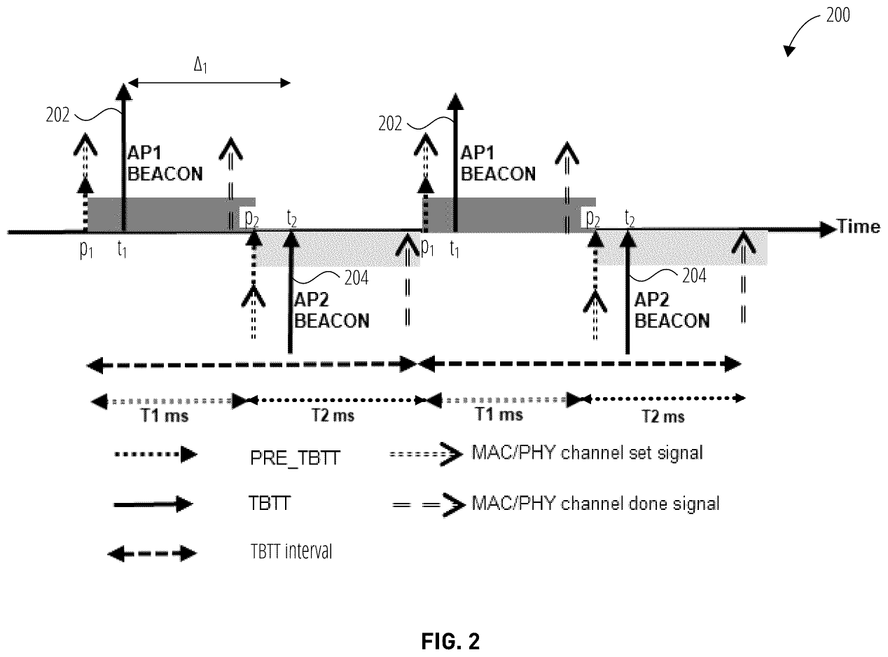

In various embodiments, the VSDB logic 112 may cause each of the multiple APs to send (or receive) one or more AP beacons within a same TBTT interval (for example 102 ms). This is described in more detail below with respect to FIGS. 2-5.

In some embodiments, the VSDB logic 112 may cause multiple APs to share time within a TBTT interval based on an asymmetric time slice. For example, a first AP may have a first time-interval T1, while a second AP may have a second time-interval T2. T1 may be greater (or less than) T2. This is also described in more detail below with respect to FIGS. 2-5.

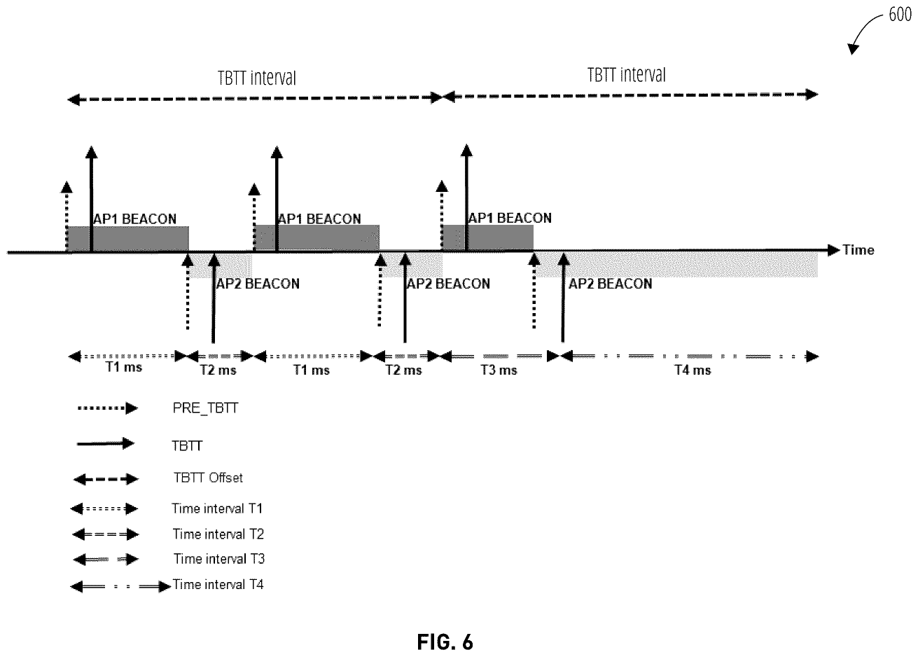

According to embodiments, one or more of the first and second time-intervals T1, T2 may be as small as 17 ms (or approximately one-sixth of the TBTT interval). In some cases, based on one or more conditions, one of the first and second time-intervals T1, T2 may be as large as 80 ms (or approximately four-fifths of the TBTT interval). This is described below in more detail with respect to FIGS. 6-9.

In some embodiments, based on one or more conditions of the first or second AP, one or more of the first and second APs may not operate (e.g., send an AP beacon) within a particular TBTT interval. In at least one of these embodiments, one of the first or second APs may operate during the entire duration of the TBTT interval. This is also described below in more detail with respect to FIGS. 6-9.

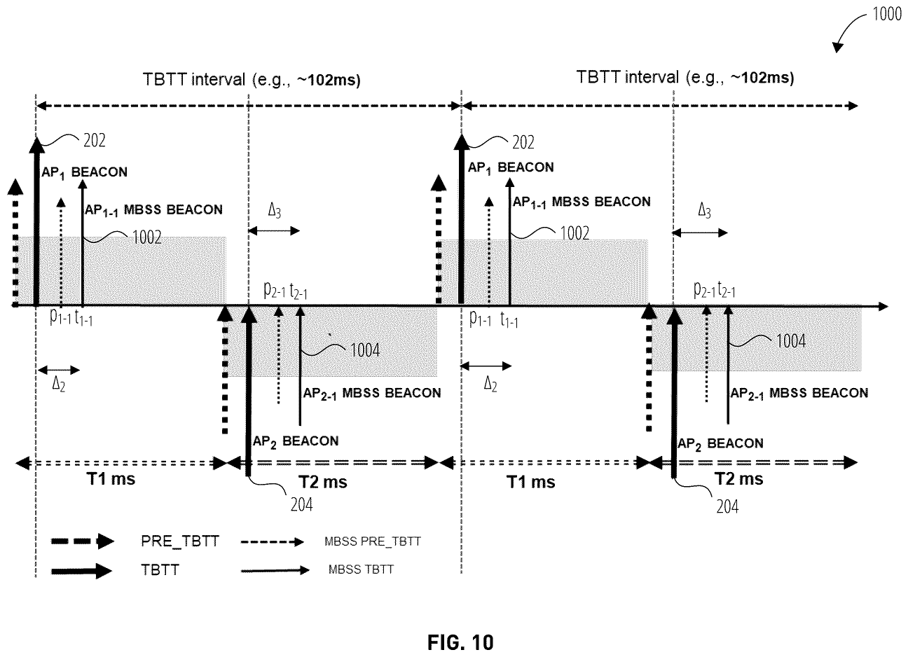

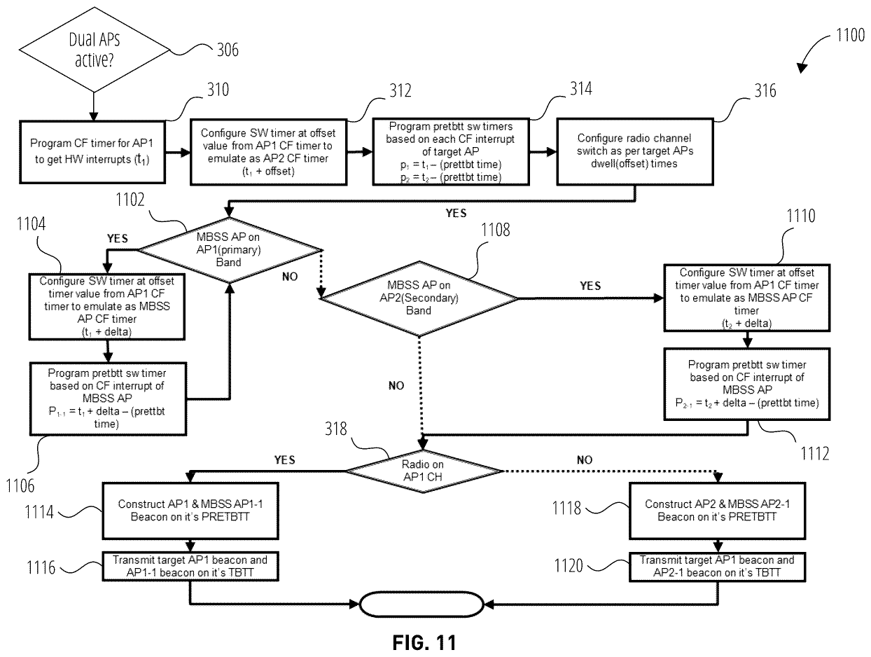

In some embodiments, more than two APs may be active concurrently. For example, VSDB logic 112 may allow the MAC/PHY Core 102 to operate more than one network within a first band (e.g., 5G), and than one network within a second band (e.g., 2.4G or 6G), by sharing time within a target beacon transmission time (TBTT) interval among the bands. The MBSS APs may have a different configuration from AP1 and AP2 such as security settings which have fewer encryption requirements like a guest network. This is described in more detail below with respect to FIGS. 10-11. In at least some of these embodiments, at least one primary network and at least one secondary network may be operated within a same band according to multiple basic service set (MBSS) protocol. The primary network may handle secured communication, such as communication between the wireless device 100 and a media display screen integrated within a vehicle (e.g., in embodiments where the wireless device 100 is integrated within the vehicle). The secondary network may handle connections to guest devices (i.e., devices that are not part of the primary network). This is described in more detail with respect to FIGS. 10-11.

FIG. 2 is a timing diagram 200 illustrating the VSDB logic 112 operating multiple APs within a single TBTT interval, according to one embodiment. The timing diagram 200 illustrates time sharing between two APs. The first RF chain 104 and the second RF chain 108 may be assigned to different APs during different time intervals according to a current TDM schedule. For example, the first and second RF chains 104, 108 may be assigned to a first AP (AP1) over a first time interval (T1) and, during a second time interval (T2), the first and second RF chains 104, 108 may be assigned to a second AP (AP2). The first AP AP1 and the second AP AP2 may operate on different frequency bands (e.g., AP1 on 5G, AP2 on 2G) in TDM fashion. The horizontal axis of the timing diagram 200 may represent time.

As illustrated in FIG. 2, The VSDB logic 112 may cause the first AP AP1 to send one or more of a pre_TBTT signal (PRE_TBTT) and a MAC/PHY channel set signal. Generally, pre_TBTT signals may prepare the first AP AP1 and any associate wireless clients for the upcoming transmission of a beacon frame, such as the AP1 beacon 202. Beacon frames may facilitate network synchronization and communication. Pre_TBTT signals may perform various functions, such as ensuring that the corresponding AP and connected wireless clients are synchronized and ready to transmit/receive the corresponding beacon at the predetermined TBTT, reduce timing drift between the corresponding AP and connected devices, and/or wake up power-saving devices in the network. MAC/PHY channel set signals may refer to signal(s) or command(s) sent by the corresponding AP to configure or select the appropriate MAC channel settings before transmission. In some embodiments, MAC/PHY channel set signals may include the corresponding pre_TBTT signal, which may trigger the allocation of MAC/PHY resources for the corresponding AP.

After the pre_TBTT signal and MAC/PHY signals are sent by the first AP AP1, the first AP AP1 may send the AP1 beacon 202. After sending the AP1 beacon 202, the VSDB logic 112 may cause the first AP AP1 operate (e.g., to receive communications from any connected devices) for a period of time. At or near the end of this period of time, the VSDB logic 112 may cause the first AP AP1 to send a MAC/PHY channel done signal to be sent. This MAC/PHY channel done signal may indicate to the MAC and/or PHY that resources that had been allocated to the first AP AP1 may be deallocated.

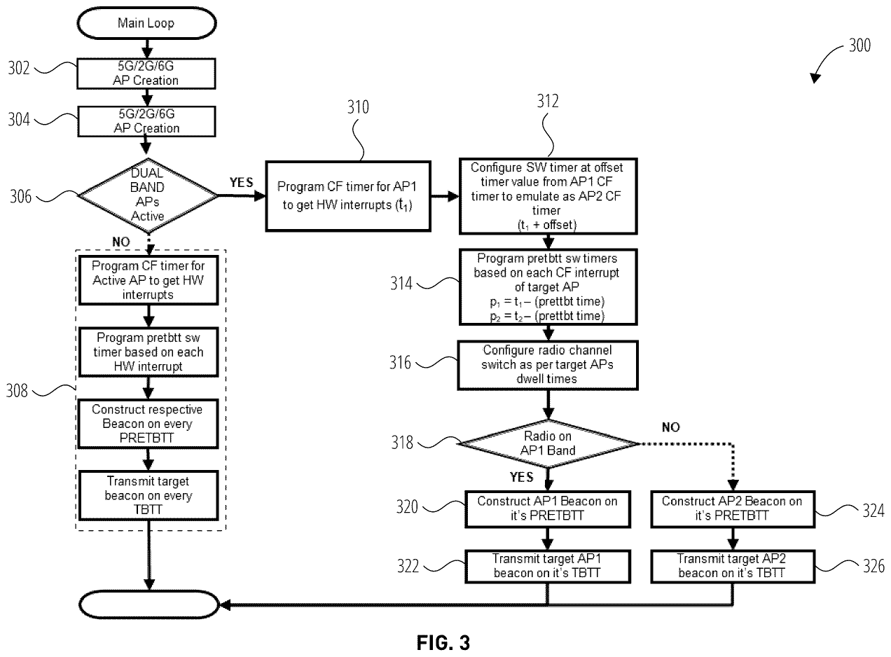

In at least some embodiments, the first AP AP1 may send one or more of the corresponding pre_TBTT signal, the MAC/PHY set or done signals, or the AP1 beacon 202 based on the CF HW timer of the MAC/PHY core 102. In one embodiment, one or more of these signals may also be sent based on one or more SW offsets. This is explained in more detail in FIG. 3.

After resources of the MAC and/or PHY are deallocated from the first AP AP1, the VSDB logic 112 may cause the second AP AP2 to send corresponding pre_TBTT and MAC/PHY channel set signals. Then, at a predetermined time, the AP AP2 may send an AP2 beacon 204 and communicate with any devices connected to the wireless device 100 via the second AP AP2. Then, the VSDB logic 112 may cause the second AP AP2 to send a corresponding MAC/PHY channel done signal.

In at least some embodiments, the second AP AP2 may send one or more of the corresponding pre_TBTT signal, the MAC/PHY set or done signals, or the AP2 beacon 204 based on a SW CF timer and/or one or more SW offsets. The SW timer and SW offsets may be determined based on the CF HW timer. This is explained in more detail in FIG. 3.

In some embodiments, at least one AP1 beacon 202 and at least one AP2 beacon 204 may be sent by the wireless device 100 within a same TBTT interval, as illustrated. Time periods corresponding to operations of each of the first and second APs AP1, AP2 may be determined by time slices. In context of VSDB, a time slice may refer to a distinct period during which the wireless device allocates resources (such as the MAC/PHY core 102) to operate within one AP before switching to another AP in subsequent time slices. Time slices corresponding to each of the first and second APs AP1, AP2 may be designed such that distinct periods during which the multiple APs operate (e.g., two APs or more) do not belong to consecutive TBTT intervals. In other words, time slices corresponding to multiple APs may maintain a predefined TBTT schedule. For example, as illustrated, if the TBTT interval is approximately 102 ms, a time slice may cause the first AP AP1 to operate (e.g., send an AP1 beacon 202 and communicate with connected devices) for approximately one-half of the TBTT interval (e.g., the first time interval T1=51 ms), and the second AP AP2 to operate for approximately one-half of the TBTT interval (e.g., the second time interval T2−51 ms). In another embodiment, a time slice may cause the first AP AP1 to operate two distinct times for approximately one-fourth of the TBTT interval (e.g., ~25 ms), and the second AP AP2 to operate two distinct times for approximately one-fourth of TBTT interval. In another embodiment, a time slice may cause the first AP AP1 to operate three distinct times for approximately one-sixth of the TBTT interval (e.g., ~17 ms), and the second AP AP2 to operate three distinct times for approximately one-sixth of the TBTT interval.

FIG. 3 is a flowchart illustrating a method 300 of operating multiple APs within a single TBTT interval, according to one embodiment. The method 300 may be performed by processing logic that may comprise hardware (e.g., circuitry, dedicated logic, programmable logic, microcode, etc.), software (e.g., instructions run on a processing device to perform hardware simulation), firmware, or a combination thereof. In at least one embodiment, the processing logic may refer to one or more portions of a wireless device, such as a MAC layer, a PHY layer (e.g., MAC/PHY core 102), and/or components of one or more RF chains (e.g., first RF chain 104, second RF chain 108). According to embodiments, the processing logic may refer to one or more processing devices of a wireless device. The processing logic may include one or more processing devices and a memory storing instructions that, when executed by the one or more processing devices, perform the method 300. One or more operations of the method 300 may be performed by the VSDB logic 112, as described herein. In at least one embodiment, the processing logic includes the VSDB logic 112. The method 300 can be performed at least partially by other devices described herein.

At block 302, the processing logic may generate a first AP. At block 304, the processing logic may generate a second AP. The first and second APs may operate within any frequency band. In some embodiments, one or more of the first and second APs may operate corresponding to one or more wireless local area networks (WLANs). Generating an AP can generically include selecting the frequency band and configuring parameters such as the Service Set Identifier (SSID), which defines the network name, and the channel on which the AP will operate. Appropriate wireless protocol settings are then loaded that match the capability of the selected frequency band. Security protocols like WPA2 or WPA3 may also initialized, ensuring the generated AP is capable of providing secure communication. Once these initial configurations are set, the generated AP may be brought online, broadcasting the SSID and allowing wireless devices (STAs) to discover and connect.

At decision block 306, the processing logic may determine whether dual band APs are active. The processing logic may determine that dual band APs are active if at least two APs have been generated within different bands. For example, if the first AP is generated within the 2.4G frequency band and the second AP is generated within the 5G frequency band, the processing logic may determine that dual band APs are active. In embodiments where dual band APs are active, components of each RF chain (eg., first RF chain 104, second RF chain 108) may be alternately assigned to the respective first and second APs in time-division fashion.

In the event that the processing logic determines that dual band APs are not active, the respective first and second APs may operate within a same frequency band. Here, at blocks 308, the processing logic may perform operations of the respective first and second APs in a time division manner. The processing logic may program the CF HW timer of the MAC/PHY core (e.g., MAC/PHY core 102) for active AP(s) to get HW interrupts. The processing logic may program a pre_TBTT SW timer based on each of these HW interrupts. The processing logic may construct respective pre_TBTT beacons based on these pre_TBTT SW timer(s), and transmit target beacon(s) on every TBTT of active AP(s).

At block 310, in the event that the processing logic determines that dual band APs are active, the processing logic programs the CF HW timer for the first AP (AP1) to get HW interrupts. These HW interrupts may correspond to one or more times where the TBTT corresponding to the first AP is scheduled to be transmitted. This HW interrupt may be represented by t₁.

At block 312, after determining t₁, the processing logic may configure a first SW timer at a first offset value from the CF HW timer to emulate as a CF timer for the second AP. This first SW timer (represented by t₂) may be defined by a combination of t₁ and the first offset value (represented by Δ₁): t₂=t₁+Δ₁. For example, as shown in FIG. 2. In at least one embodiment, the first SW timer may be the first offset value as compared to the CF HW timer.

At block 314, the processing logic may program a second SW timer (represented by p₁) and a third SW timer (represented by p₂) based on the first and second SW timers: p₁=t₁-(pre_TBTT time); p₂=t₂-(pre_TBTT time). The second and third SW timers p₁, p₂ may be based on each CF interrupt of the respective first and second APs. By way of example as shown in FIG. 2, the second and third SW timers p₁, p₂ may be a predetermined amount of time before their respective TBTTs and helps ensure that each AP is prepared to send its respective beacon at the scheduled TBTT, and/or that each respective connected device (e.g., STA) is prepared to receive the beacon (e.g., transitions from power-saving mode to active mode). In at least one embodiment, the second and third SW timers may be offset values as compared to the CF HW timer.

At block 316, the processing logic configures a radio channel switch as per respective AP target dwell times. Generally, AP dwell time refers to an amount of time that an Access Point (AP) spends on a particular channel during operation. In scenarios where the AP is switching between channels, such as during a scan for other networks or while operating in certain channel-hopping configurations (e.g., in dynamic frequency selection or mesh networking), the target dwell time defines how long the AP remains on one channel before moving to the next. This time period may be selected to ensure that the AP has enough time to effectively listen to the wireless medium, detect any interference, gather necessary network information, or communicate with connected stations (STAs) on that channel. According to embodiments, selecting a dwell time that is too short can result in the AP may not be able to gather sufficient information, while if the dwell time is too long, it may introduce delays in operations that require switching between channels, such as handling clients on different frequencies or completing a scan of available networks.

At decision block 318, the processing logic may determine whether the radio is on the AP1 band or the AP2 band. In other words, the processing logic may determine whether the first AP is to transmits its respective beacon before the second AP, or vice versa. This determination may be optional, as the processing logic may transmit respective beacons on pre_TBTT and/or TBTT based on the determined HW and SW timers t₁, t₂, p₁, p₂.

At 320, the processing logic may construct the AP1 beacon (beacon corresponding to the first AP) on the respective pre_TBTT. The processing logic may construct the AP1 beacon based on the second SW timer p₁. Generally, constructing an AP beacon can involve creating a management frame that the respective AP regularly transmits to announce its presence and provide critical information to nearby client devices (STAs). The beacon frame can contains several components, including but not limited to one or more of a Frame Control field, which identifies the type of frame and its specific function as a beacon, a Timestamp, which helps synchronize the AP with the connected devices by indicating the precise time when the beacon was generated, a service set identifier (SSID), which identifies the network name broadcast by the AP, allowing devices to recognize the available network, a Supported Data Rates field, which informs STAs of the speeds at which the AP can communicate, a Beacon Interval that specifies how often the beacon will be transmitted, or a Traffic Indication Map (TIM), which helps STAs in power-saving mode determine if the AP has any buffered data waiting for them. The AP beacon can also include security and capability information, such as supported encryption methods and Quality of Service (QoS) capabilities, to enable devices to connect securely and optimize performance.

At block 322, the processing logic may transmit the AP1 beacon on the corresponding TBTT. As explained above, this corresponding TBTT may be represented by the HW interrupt t₁. So, in at least some embodiments, the processing logic transmits the AP1 beacon based on the HW interrupt t₁.

At block 324, the processing logic may construct the AP2 beacon (beacon corresponding to the second AP) on the respective pre_TBTT. The processing logic may construct the AP2 beacon based on the third SW timer p₂.

At block 326, the processing logic may transmit the AP2 beacon on the corresponding TBTT. As explained above, this corresponding TBTT may be represented by the second SW timer t₂. So, in at least some embodiments, the processing logic transmits the AP2 beacon based on the second SW timer t₂. In some embodiments, the second, third, and fourth SW timers t₂, p₁, p₂ may be considered SW interrupts. In at least one embodiment, the second, third, and fourth SW timers t₂, p₁, p₂ may emulate HW interrupts, such as HW interrupt t₁ determined by programing the CF HW timer.

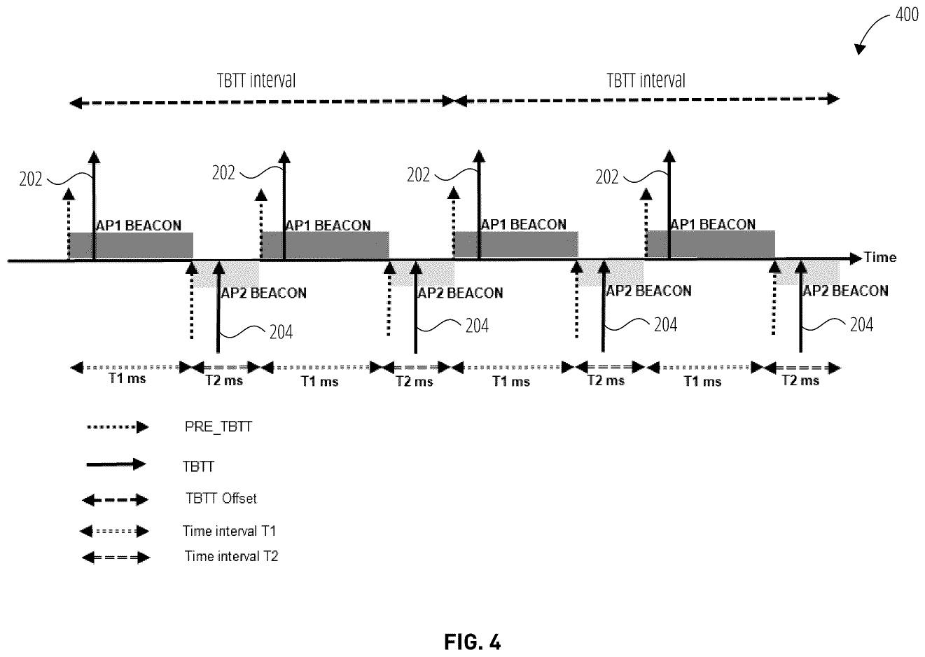

FIG. 4 is a timing diagram 400 illustrating the VSDB logic 112 operating multiple APs within a single TBTT interval according to asymmetrical time slices, according to one embodiment. The timing diagram 400 illustrates time sharing between two APs, similar to the timing diagram 200 of FIG. 2. The first RF chain 104 and the second RF chain 108 may be jointly assigned to different APs according to the current time division schedule. For example, the first and second RF chains 104, 108 may be assigned to a first AP (AP1) at a first time, and at a second time, the first and second RF chains 104, 108 may be assigned to a second AP (AP2). The horizontal axis of the timing diagram 200 may represent time.

In some embodiments, each AP (e.g., the first and second APs) may transmit multiple beacons during a single TBTT interval. For example, as illustrated, the AP1 beacon 202 and AP2 beacon 204 may each be transmitted twice during a single TBTT interval.

In at least some embodiments, each TBTT interval may be partitioned into asymmetrical time slices. Each AP may have an assigned time slice during which respective APs are given the medium. In at least one embodiment, each time slice may correspond to a scheduled pre_TBTT and TBTT. Each time slice may begin with a scheduled pre_TBTT. According to embodiments, each AP may correspond to a time slice. For example, the first AP may correspond to a first time slice T1, while the second AP may correspond to a second time slice T2. In at least one embodiment, the first time slice T1 may be larger than the second time slice T2. However, in another embodiment, the second time slice T2 may be larger than the first time slice T1. As illustrated, transitions between the first and second time slices T1, T2 each correspond to a scheduled pre_TBTT. These transitions also correspond to switches between the first and second APs.

In at least some embodiments, these time slices are predetermined such that they fit within the TBTT interval. For example, if a TBTT interval is 100 TUs, and two beacons for each AP are desired during the TBTT interval, T1 and T2 may be selected such that. Here, as an exemplary embodiment, the first time slice T1 may be 33 TU and the second time slice T2 may be 17 TU. In another embodiment, the first time slice may be 35 TU and the second time slice may be 15 TU. If the TBTT interval is approximately 102 ms and three beacons for each AP are desired during the TBTT interval, T1 and T2 may be selected such that. Here, as an exemplary embodiment, the first time slice T1 may be approximately 19 ms and the second time slice T2 may be approximately 15 ms. In another embodiment, the first and second time slices T1, T2 may each be approximately 17 ms. These time slices may be selected such that APs that are more congested (i.e., have more traffic) or handle latency-sensitive data may have longer time slices as compared to other APs.

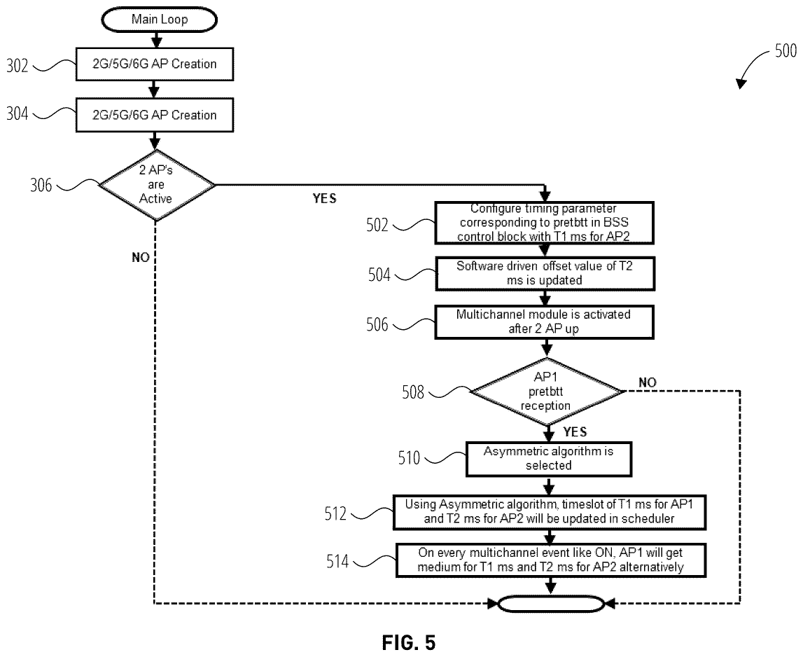

FIG. 5 is a flowchart illustrating a method 500 of operating multiple APs within a single TBTT interval according to asymmetrical time slices, according to one embodiment. The method 500 may include some or all of the features described above with respect to FIGS. 1-4. The method 500 may be performed by processing logic that may comprise hardware (e.g., circuitry, dedicated logic, programmable logic, microcode, etc.), software (e.g., instructions run on a processing device to perform hardware simulation), firmware, or a combination thereof. In at least one embodiment, the processing logic may refer to one or more portions of a wireless device, such as a MAC layer, a PHY layer (e.g., MAC/PHY core 102), and/or components of one or more RF chains (e.g., first RF chain 104, second RF chain 108). According to embodiments, the processing logic may refer to one or more processing devices of a wireless device. The processing logic may include one or more processing devices and a memory storing instructions that, when executed by the one or more processing devices, perform the method 500. One or more operations of the method 500 may be performed by the VSDB logic 112, as described herein. In at least one embodiment, the processing logic includes the VSDB logic 112. The method 500 can be performed at least partially by other devices described herein.

A first AP AP1 and a second AP AP2 may be generated or otherwise created as described above with respect to FIG. 3. The processing logic may also determine that at least two APs are active, similar to decision block 306 as described above. However, here, the processing logic may only determine that two different APs are active. Here, the APs may be part of a same band.

At block 502, the processing logic may configure the third SW timer p₂ (e.g., a timing parameter) based on a first time slice T1 corresponding to the first AP AP1. In other words, the third SW timer p₂ may be configured such that p₂=p₁+T1, where the first time slice T1 is an offset value (i.e., similar to the first offset value Δ₁ as described in FIG. 3). By doing so, the processing logic may grant the first AP AP1 access to the medium during the first time slice T1, and schedule the second AP AP2 to access the medium after the first time slice T1 expires. The second SW timer t₂, which represents the TBTT corresponding to the second AP AP2 (i.e., when the AP2 beacon 204 is to be transmitted), may be determined by t₂=p₂+(pre_TBTT time)=p₁+T₁+(pre_TBTT time). In at least one embodiment, the second, and fourth SW timers t₂, p₁, p₂ may be stored in a basic service block (BSS) control block with T1 ms for the second AP AP2, while the HW timer t₁ and third SW timer p₁ may be stored in the BSS control block for the first AP AP1.

At block 504, the process logic may update the second SW timer p₁ based on the second time slice T2. Here, the second time slice T2 may be used as an offset value, as illustrated by the following equation:

p₁=p₂+T2.

By doing so, the processing logic may schedule a pre_TBTT beacon corresponding to the first AP AP1 at the expiration of the second time slice T2. In other words, the processing logic may grant the first AP AP1 access to the medium after the second time slice T2 expires.

At block 506, the processing logic may activate a multichannel module. In general, multichannel modules may refer to a combination of hardware, firmware, or software that is capable of handling multiple communication channels concurrently. In other words, a multichannel module may be a hardware or firmware component (with or without software) responsible for managing multiple communication channels concurrently. The multichannel module may enable parallel transmission and reception across various frequency channels. The multichannel module may allow for dynamic channel allocation, adapting to interference or congestion by shifting communication to less crowded frequencies. The multichannel module may also support features like channel bonding, which combines multiple channels into a single, wider band to increase bandwidth.

At decision block 508, the processing logic may determine whether it is appropriate to proceed with a scheduled beacon transmission corresponding to the first AP AP1 or delay the scheduled beacon transmission based on the reception of incoming signals during the pre_TBTT period. This decision could involve checking for potential channel interference, determining if there are ongoing transmissions from other devices, or receiving important control frames that may alter the timing or content of the beacon. The processing logic may also assess whether network parameters need updating, such as adjusting power levels, modifying channel settings, or coordinating with other access points to avoid collisions.

At block 510, the processing logic may determine whether an asymmetric schedule (also referred to as algorithm) is selected. This asymmetric schedule may cause the time slices corresponding to the active APs (e.g., first time slice T1, second time slice T2) to be asymmetric. The asymmetric schedule may be selected for any number of reasons, including but not limited to prioritizing an active AP handling latency-sensitive data, prioritizing an active AP handling significantly more traffic than another active AP, or the like. In at least one embodiment, the asymmetric schedule may be selected by default.

At block 512, the processing logic may update a scheduler to have time slots for the first and second APs AP1, AP2 that correspond to their respective first and second time slices T1, T2. This scheduler may be part of the VSDB logic 112. In at least one embodiment, this scheduler may be part of the multichannel module.

At block 514, the processing logic may cause the first and second APs AP1, AP2 to alternate having access to the medium. In some embodiments, the processing logic may cause the first AP AP1 to have access to the medium for a period of time corresponding to the first time slice T1, and the second AP AP2 to have access to the medium for a period of time corresponding to the second time slice T2.

FIG. 6 is a timing diagram 600 illustrating the VSDB logic 112 modifying time slices, according to one embodiment. The timing diagram 600 illustrates time sharing (i.e., time division multiplexing (TDM)) between two active APs, similar to the timing diagram 400 as illustrated in FIG. 4 and the timing diagram 200 as illustrated in FIG. 2. The first RF chain 104 and the second RF chain 108 may be assigned to different APs at different times according to a time division multiplexing schedule. For example, the first and second RF chains 104, 108 may be assigned to a first AP (AP1) at a first time and, at a second time, the first and second RF chains 104, 108 may be assigned to a second AP (AP2). The horizontal axis of the timing diagram 200 may represent time.

According to embodiments described within, the active APs (here, AP1 and AP2) may alternate using the wireless medium based on a first schedule (e.g., TDM schedule) that divides a TBTT interval into symmetrical or asymmetrical time slices. However, one or more conditions may cause the VSDB logic 112 to modify this time division by implementing a second schedule that causes the active APs to share the medium based on different time slices. For example, in the event that the wireless device 100 is to perform off-channel operations, such as neighbor discovery, WLAN direct scan (e.g., Wi-Fi® direct scan), or the like, the VSDB logic 112 may implement a second schedule that prioritizes medium access for an AP that is to perform the off-channel operation. Another example may include prioritizing medium access for an AP that is performing a network onboarding process, such as a wireless local area network (WLAN) onboarding process. According to embodiments, any suitable reason for prioritizing medium access for an AP, such as those described above, handling latency-sensitive data, increased traffic, performing one or more network management operations, or the like, may be a condition that causes the VSDB logic 112 to modify the time division between active APs.

The timing diagram 600 illustrates modifying time slices between TBTT intervals, according to one embodiment. In a first TBTT interval (i.e., the TBTT interval on the left), time sharing between AP1 and AP2 is based on asymmetrical time slices T1 (the first time slice) and T2 (the second time slice). These first and second time slices T1 and T2 may be the same or similar to those described above with respect to FIG. 4 and FIG. 5. In a second TBTT interval following the first TBTT interval (i.e., the TBTT interval in the right), time sharing between AP1 and AP2 is based on asymmetrical time slices T3 (a third time slice) and T4 (a fourth time slice). Here, medium access for the AP2 has been prioritized. Medium access for the AP2 may have been prioritized based on one or more of a variety of factors or conditions, such as those described above and others. The third and fourth time slices T3, T4 may be different from the first and second time slices T1, T2. In some embodiments, as illustrated, one of the third and fourth time slices T3, T4 may be a majority of the second TBTT interval (here, the fourth time slice T4). In at least one embodiment, one of the third and fourth time slices T3, T4 may be the entire second TBTT interval. Here, the non-prioritized AP may not have access to the medium during the second TBTT interval.

In embodiments where the first and second TBTT intervals are approximately 102 ms, the third time slice T3 may be approximately 20 ms and the fourth time slice T4 may be approximately 80 ms. The third time slice T3 may be as small as 0 ms, while the fourth time slice T4 may be as large as approximately 102 ms. The third time slice T3 may be as large as approximately 50 ms, while the fourth time slice may be as small as approximately 52 ms. In other words, the non-prioritized AP may have access to the medium for a smaller amount of time (or none at all) as compared to the prioritized AP.

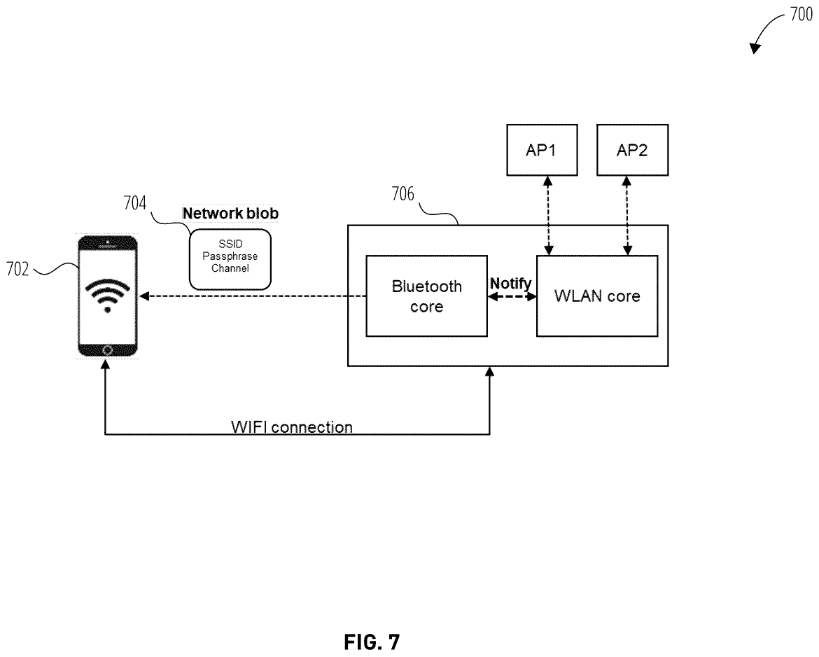

FIG. 7 illustrates a communication system 700 including a client device 702 and a wireless device 706, according to one embodiment. The wireless device 706 may include some or all of the features of wireless device 100 as described herein. In at least some embodiments, the client device 702 and wireless device 706 may be performing a WLAN onboarding process. Generally, WLAN onboarding refers to a process by which the client device 702 connects to and becomes authorized to use a wireless network. The client device 702 may be any electronic device equipped with wireless communication capabilities, such as a smartphone, tablet, laptop, or Internet of Things (IoT) device. In many cases, WLAN onboarding (and onboarding in general) includes the exchange of network credentials and configuration information, collectively referred to as a network blob 704. The network blob 704 can include data such as the Service Set Identifier (SSID), passphrase, and channel information required for the client device 702 to authenticate and communicate with the WLAN. The wireless network is provided by the wireless device 706, which operates one or more APs through its WLAN core. The wireless device 706 may be equipped with both a Bluetooth® core and a WLAN core, enabling it to facilitate onboarding through multiple communication protocols.

In at least some WLAN onboarding processes, the client device 702 initiates the connection request via Bluetooth to join a wireless network operated by the wireless device 706. The client device 702 may scan for nearby Bluetooth®-enabled devices and establish a connection with the Bluetooth core of the wireless device 706. Through this Bluetooth connection, the client device 702 may proactively request access to the WLAN network. Upon receiving the request, the wireless device 706 may transmit the network blob 704 to the client device 702 over the Bluetooth link. By obtaining the network blob 704, the client device 702 can configure its WLAN settings without requiring manual input of credentials. In at least some embodiments, the Bluetooth® core may notify the WLAN core that the client device 702 will be initiating a connection using the network blob 704.

After successfully receiving and processing the network blob 704, the client device 702 may disconnect from the Bluetooth® connection and initiate a connection to the WLAN network using the configured settings. The WLAN core of the wireless device 706 may then authenticate the client device 702 based on the credentials provided in the network blob 704. Upon successful authentication, the client device 702 can be granted access to the network and can communicate with one or more of the active APs operated by the WLAN core of the wireless device 706.

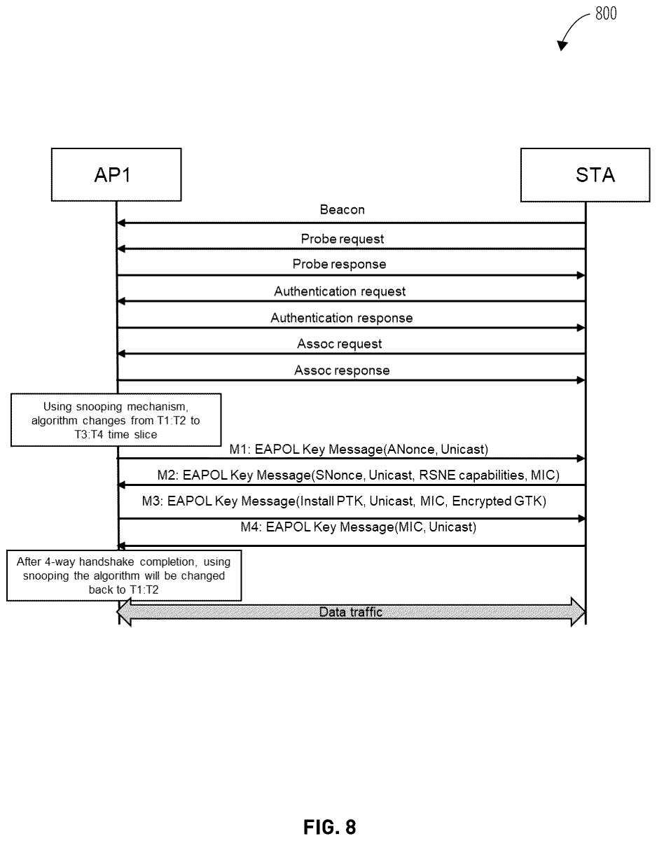

FIG. 8 is a flowchart illustrating a method 800 of performing a WLAN onboarding process, according to one embodiment. The method 800 may be performed by processing logic that may comprise hardware (e.g., circuitry, dedicated logic, programmable logic, microcode, etc.), software (e.g., instructions run on a processing device to perform hardware simulation), firmware, or a combination thereof. In at least one embodiment, the processing logic may refer to one or more portions of a wireless device, such as a MAC layer, a PHY layer (e.g., MAC/PHY core 102), and/or components of one or more RF chains (e.g., first RF chain 104, second RF chain 108). According to embodiments, the processing logic may refer to one or more processing devices of a wireless device. The processing logic may include one or more processing devices and a memory storing instructions that, when executed by the one or more processing devices, perform the method 800. One or more operations of the method 800 may be performed by the VSDB logic 112, as described herein. In at least one embodiment, the processing logic includes the VSDB logic 112. The method 800 can be performed at least partially by other devices described herein.

In some embodiments, as an initial step of the WLAN onboarding process, the station (STA) (e.g., the client device 702) sends a beacon to Access Point 1 (AP1). This action can involve the STA broadcasting a signal to announce its presence and capabilities to nearby access points. The beacon can contain information such as the STA's supported data rates and network capabilities. Alternatively, the STA may skip sending a beacon and instead listen for beacons from AP1 or other active APs to initiate the connection process passively.

Following the beacon transmission, the STA can send a probe request to AP1. This probe request may be a frame that actively seeks information about the wireless network from AP1, including supported frequencies, data rates, and network identifiers. Alternatively, the STA could send a broadcast probe request to all nearby access points or use passive scanning to receive probe responses without initiating requests.

In response to the probe request, AP1 can send a probe response to the STA. The probe response may include details about the network's capabilities, such as supported data rates, encryption types, and other operational parameters. Alternatively, if the STA had passively received AP1's beacon, this step might be omitted as the STA would already have the necessary information to proceed.

The STA then can send an authentication request to AP1. This request may initiate the authentication process and typically includes information necessary for AP1 to verify the STA's identity. The authentication method could be an open system, a shared key system, or a similar system. Alternatively, the STA may employ other authentication protocols that utilize pre-shared keys depending on the network's security configuration.

Upon receiving the authentication request, AP1 can send an authentication response to the STA. This response may indicate whether the STA has been authenticated successfully or if further authentication is required. Additionally, AP1 may challenge the STA with additional authentication steps, such as requesting credentials or certificates, especially in networks with higher security requirements.

After successful authentication, the STA can send an association request to AP1. This request can include information about the STA's desired network parameters, such as QoS capabilities, power management settings, and supported data rates. Additionally, the STA may include additional elements like vendor-specific information or request specific network resources based on its application needs.

The AP1 can then respond with an association response to the STA. The association response can confirm the establishment of an association between the STA and AP1 and assigns an Association ID (AID) to the STA. Alternatively, AP1 may deny the association if it cannot support additional devices or if the STA's capabilities are incompatible with the network requirements.

In at least some embodiments, the VSDB logic 112 may prioritize the AP1 over another active AP (e.g., AP2) and modify how the active APs time share within one or more consecutive TBTT intervals. The AP1 may be prioritized during the handshake between the AP1 and STA, as described below. As described above in FIG. 7, the VSDB logic 112 may change from using a first timing schedule with initial time slices (e.g., the first time slice T1 and the second time slice T2) to a second timing schedule with different time slices (e.g., the third time slice T3 and the fourth time slice T4). In at least one embodiment, a snooping mechanism may be used to determine when the AP1 sends the association response to the STA. The snooping mechanism may be any device or program that monitors or otherwise observes network traffic without actively participating in the communication. Here, any suitable snooping mechanism may be used, such as a WiFi® frame snooping mechanism.

The AP1 may initiate the secure key exchange by sending a first EAPOL-Key (Extensible Authentication Protocol over LAN key) message to the STA. This message includes the Authenticator Nonce (ANonce) and is sent unicast to the STA. The ANonce is a randomly generated number used to ensure the freshness of the key exchange. Alternatively, AP1 may include additional security parameters or utilize different key management protocols depending on the network's security settings.

The STA responds by sending a second EAPOL-Key message to AP1. This message may contain the Supplicant Nonce (SNonce), RSN (Robust Security Network) capabilities, and a Message Integrity Code (MIC), and is sent unicast. The SNonce is another random value generated by the STA. Alternatively, the STA may include additional authentication data or request specific encryption algorithms if supported by the network.

The AP1 can then respond to the STA with a third EAPOL-Key message. This third message can instruct the STA to install the Pairwise Transient Key (PTK), includes a MIC, and provides the Encrypted Group Temporal Key (GTK), all sent unicast. The PTK is used for encrypting unicast traffic between the STA and AP1, while the GTK is used for multicast and broadcast traffic. Alternatively, AP1 might send multiple GTKs if the network supports multiple multicast groups or employ different encryption standards.

The STA can then complete the handshake by sending a fourth EAPOL-Key message to AP1. This fourth message can include a MIC and is sent unicast, confirming that the STA has successfully installed the PTK and received the GTK. Alternatively, if there is a failure in key installation, the STA may request retransmission of the keys or abort the connection attempt.

Once the handshake is complete, the VSDB logic 112 may de-prioritize the AP1 and revert back to using the initial time slices of the first timing schedule (e. g, the first time slice T1 and the second time slice T2). The snooping mechanism may again be used to determine when the handshake is completed. Once the handshake is complete and the AP1 is de-prioritized, data traffic between AP1 and the STA may ensue, and the STA may send and receive data securely over the WLAN.

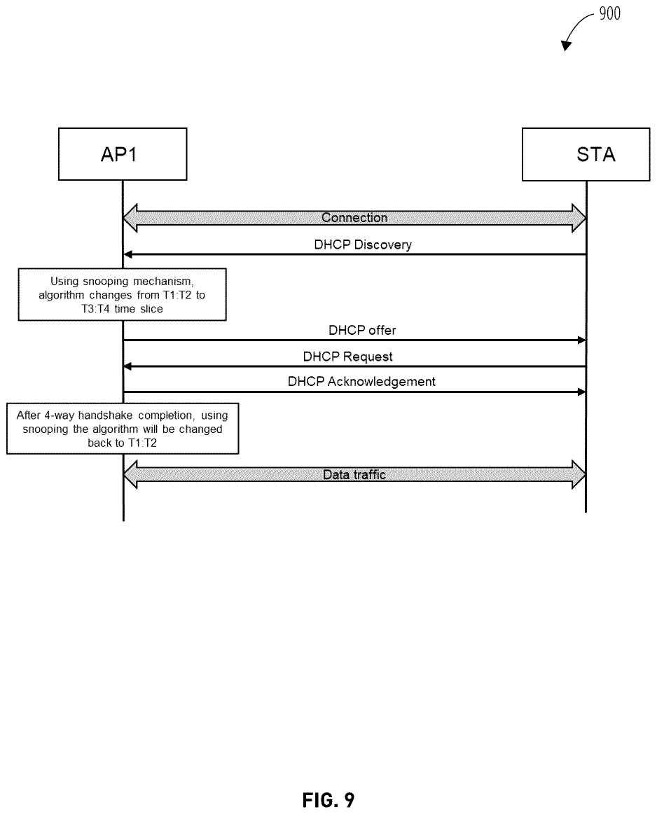

FIG. 9 is a flowchart illustrating a method 900 of performing a dynamic host configuration protocol (DHCP) discovery and onboarding process, according to one embodiment. The method 900 may be performed by processing logic that may comprise hardware (e.g., circuitry, dedicated logic, programmable logic, microcode, etc.), software (e.g., instructions run on a processing device to perform hardware simulation), firmware, or a combination thereof. In at least one embodiment, the processing logic may refer to one or more portions of a wireless device, such as a MAC layer, a PHY layer (e.g., MAC/PHY core 102), and/or components of one or more RF chains (e.g., first RF chain 104, second RF chain 108). According to embodiments, the processing logic may refer to one or more processing devices of a wireless device. The processing logic may include one or more processing devices and a memory storing instructions that, when executed by the one or more processing devices, perform the method 900. One or more operations of the method 900 may be performed by the VSDB logic 112, as described herein. In at least one embodiment, the processing logic includes the VSDB logic 112. The method 900 can be performed at least partially by other devices described herein.

At the initial stage of the DHCP discovery and onboarding process, the Access Point 1(AP1) and the Station (STA) establish or initiate a connection. This connection may occur after the STA has successfully completed WLAN association and authentication with AP1, as previously described above with respect to the method 800 of FIG. 8. After connection, the STA and AP1 may be prepared to communicate at the network layer.

Following the establishment of the connection, the STA sends DHCP discovery frame(s) to AP1. In some embodiments, the STA may broadcast a DHCPDISCOVER message to identify available DHCP servers on the network. This message can help the STA obtain an IP address and other network configuration parameters necessary for network communication. Alternatively, if the STA is aware of the DHCP server's address, the STA may send the DHCPDISCOVER message directly (unicast) to AP1 or another designated DHCP server. In some cases, the STA might utilize DHCPv6 or other address configuration protocols, such as IPv6 Stateless Address Autoconfiguration (SLAAC), as an alternative to DHCP.

In at least some embodiments, the VSDB logic 112 may prioritize the AP1 over another active AP (e.g., AP2) and modify how the active APs time share within one or more consecutive TBTT intervals. The AP1 may be prioritized during a DHCP handshake (i.e., one or more of discovery, offer, request, or acknowledgement communications) between the AP1 and STA, as described below. As described above in FIG. 7, the VSDB logic 112 may change from using a first timing algorithm with initial time slices (e.g., the first time slice T1 and the second time slice T2) to a second timing schedule with different time slices (e.g., the third time slice T3 and the fourth time slice T4). In at least one embodiment, a snooping mechanism may be used to determine when the AP1 receive the DHCP discovery frame(s) or when the AP1 and STA are to perform a DHCP handshake. The snooping mechanism may be any device or program that monitors or otherwise observes network traffic without actively participating in the communication. Here, any suitable snooping mechanism may be used, such as a WiFi® frame snooping mechanism.

Upon receiving the DHCP discovery message, the AP1 can respond by sending a DHCP offer to the STA. The DHCPOFFER message can include an available IP address for the STA, along with subnet mask, default gateway, DNS server addresses, and lease duration information. This offer can enable the STA to configure its network interface with the provided settings. Alternatively, AP1 may act as a relay agent, forwarding the DHCPDISCOVER message to an external DHCP server and relaying the DHCPOFFER back to the STA.

The STA can then send a DHCP request to AP1, indicating acceptance of the offered IP address and associated network parameters. This DHCPREQUEST message may confirm the STA's intent to use the provided configuration and informs other potential DHCP servers that their offers have been declined. The STA may also request specific options or modifications to the offered parameters in this message.

AP1 responds to the STA with a DHCP acknowledgment. The DHCPACK message finalizes the lease agreement, confirming that the STA may use the specified IP address and network settings for the duration of the lease. This message may also include additional configuration details, such as time server addresses or network boot parameters. Alternatively, if the requested IP address is no longer available or if there is a configuration conflict, AP1 may send a DHCP negative acknowledgment (DHCPNAK), prompting the STA to restart the discovery process. In some implementations, the DHCPACK may be supplemented with security measures, like DHCP authentication, to enhance network security.

Once the DHCP handshake is complete, the VSDB logic 112 may de-prioritize the AP1 and revert back to using the initial time slices of the first timing schedule (e. g, the first time slice T1 and the second time slice T2). The snooping mechanism may again be used to determine when the DHCP handshake is completed. With the DHCP process completed, data traffic may ensue between AP1 and the STA. The STA may now be able to communicate on the network using its assigned IP address, enabling access to network resources, internet connectivity, and communication with other devices.

FIG. 10 is a timing diagram 1000 illustrating the VSDB logic 112 operating multiple active APs within same frequency bands during TBTT intervals, according to one embodiment. The timing diagram 1000 may illustrate an extension of the timing diagram 200 of FIG. 2, where along with AP1 on a first frequency band (e.g., 5G) and AP2 on a second frequency band (e.g., 2G) operating in TDM fashion, same-band APs (MBSS) AP1-1/AP2-1 can also be brought up running parallel to AP1 or AP2 based on newly-generated SW-driven CF timers (or offsets). For example, these same-band APs AP1-1 and AP2-1 may each operate within the first time interval T1 and the second time interval T1 as described herein with respect to the first AP AP1 and the second AP AP2. The timing diagram 1000 may include one or more features described above with respect to FIGS. 1-9. The first RF chain 104 and the second RF chain 108 may each be assigned to multiple APs at different times according to a current TDM schedule. For example, the first and second RF chains 104, 108 may be assigned to a first AP (AP1) and a third AP (AP1-1) over a first time interval (T1), and over a second time interval (T2), the first and second RF chains 104, 108 may be assigned to a second AP (AP2) and a fourth AP (AP2-1). The horizontal axis of the timing diagram 200 may represent time.

According to embodiments described within, the active APs (here, AP1, AP2, AP1-1, and AP2-1) may alternate using the wireless medium based on predefined time slices. During the first time interval T1, AP1 and AP1-1 may contend for the medium, and during the second time interval T2, Ap2 and AP2-1 may contend for the medium. This may be because AP1 and AP1-1 share same channel(s), and AP2 and AP2-1 share same channel(s). In some embodiments, AP1 and AP2 may belong to one or more first networks (e.g., a primary network, a primary WLAN), while AP1-1 and AP2-1 may belong to one or more secondary networks (e.g., a secondary network, a secondary WLAN, MBSS). In various embodiments, these networks may be separated according to MBSS protocol. MBSS protocol can establish primary and secondary networks to enhance the security and reliability of communications, particularly in environments with integrated devices like speakers or displays in a vehicle, such as an automobile. In such a setup, the primary network can handle general communication traffic, while the secondary network can be configured for secure communication, such as location-based functions or media control within the vehicle. By segregating these communications, the MBSS protocol can help ensure that sensitive data remains protected, and reduce the risk of unauthorized access or interference, and/or optimize network performance for specific tasks.

In at least some embodiments, the beacons of AP1-1 and AP2-1 are transmitted according to software timers or offsets relative to AP1 and AP2, respectively. For example, AP1-1 beacon 1002 may be transmitted 8 ms after AP1 beacon 202, and AP2-1 beacon 1004 may be transmitted 8 ms after AP2 beacon 204. However, AP1-1 beacon 1002 may be configured to transmit any amount of time Δ₂ after the AP1 beacon 202, as long as the AP1-1 beacon 1002 is transmitted during the first time interval T1. Likewise, AP2-1 beacon 1004 may be configured to transmit any amount of time Δ₃ after the AP2 beacon 204, as long as the AP2-1 beacon 1004 is transmitted during the second time interval T2.

FIG. 11 is a flowchart illustrating a method 1100 of operating multiple active APs within same frequency bands during TBTT intervals, according to one embodiment. The method 1100 may be performed by processing logic that may comprise hardware (e.g., circuitry, dedicated logic, programmable logic, microcode, etc.), software (e.g., instructions run on a processing device to perform hardware simulation), firmware, or a combination thereof. In at least one embodiment, the processing logic may refer to one or more portions of a wireless device, such as a MAC layer, a PHY layer (e.g., MAC/PHY core 102), and/or components of one or more RF chains (e.g., first RF chain 104, second RF chain 108). According to embodiments, the processing logic may refer to one or more processing devices of a wireless device. The processing logic may include one or more processing devices and a memory storing instructions that, when executed by the one or more processing devices, perform the method 1100. One or more operations of the method 1100 may be performed by the VSDB logic 112, as described herein. In at least one embodiment, the processing logic includes the VSDB logic 112. The method 1100 can be performed at least partially by other devices described herein.

A first AP AP1 and a second AP AP2 may be generated or otherwise created as described above with respect to FIG. 3 (with respect to at least blocks 302, 304).

The method 1100 may also include other operations of the method 300 as described above with respect to FIG. 3, such as those operations described with respect to blocks 306, 310, 312, 314, 316, and 318. As described above, the processing logic may determine whether dual band APs are active and determine the HW interrupt t₁, the first SW timer t₂, the second SW timer p₁, and the third SW timer p₂. In at least one embodiment, the processing logic may also determine that these active APs are to be operated according to MBSS protocol, as described herein.

At decision block 1102, the processing logic may determine whether AP1 is active. If active, the processing logic may configure a fourth SW timer t₁₋₁ that is to correspond with the AP1-1 beacon 1002 (i.e., TBTT of AP1-1) at block 1104. This fourth SW timer t₁₋₁ may be configured to emulate an AP CF timer, similar to the first SW timer t₂. In at least some embodiments,, where Δ₂ represents an amount of time between the wireless device 100 transmitting the AP1 beacon 202 and the wireless device 100 transmitting the AP1-1 beacon 1002. Δ₂ may also be equal to the duration of the time slice corresponding to AP1.

At block 1106, the processing logic may program a fifth SW timer p₁₋₁ based on the fourth SW timer t₁₋₁. This fifth SW timer p₁₋₁ may correspond with a pre_TBTT for AP1-1. In at least some embodiments, p₁₋₁=t₁+Δ₂-(pre_TBTT time).

If AP1 is not active (or access to the medium has transitioned to AP2), the processing logic may determine whether AP2 is active at decision block 1108. If active, the processing logic may configure a sixth SW timer t₂₋₁ that is to correspond with the AP2-1 beacon 1004 (i.e., TBTT of AP2-1) at block 1110. This sixth SW timer t₂₋₁ may be configured to emulate an AP CF timer, similar to the first SW timer t₂. In at least some embodiments,, where Δ₃ represents an amount of time between the wireless device 100 transmitting the AP2 beacon 204 and the wireless device 100 transmitting the AP2-1 beacon 1004. Δ₃ may also be equal to the duration of the time slice corresponding to AP2.

At block 1112, the processing logic may program a seventh SW timer p₂₋₁ based on the sixth SW timer t₂₋₁. This seventh SW timer p₂₋₁ may correspond with a pre_TBTT for AP2-1. In at least some embodiments, p₂₋₁=t₂+Δ₃-(pre_TBTT time).

At block 1114, the processing logic may construct the AP1 and AP1-1 beacons 202, 1002 on their respective pre_TBTT. These respective pre_TBTT may be represented by p₁ and p₁₋₁, as described above. Block 1114 may include some or all of the features of block 320 described above with respect to FIG. 3.

At block 1116, the processing logic may transmit the AP1 and AP1-1 beacons 202, 1002 on their respective TBTT. Their respective TBTT may be represented by t₁ and t₁₋₁, as described above. Block 1116 may include some or all of the features of block 322 described above with respect to FIG. 3.

At block 1118, the processing logic may construct the AP2 and AP2-1 beacons 204, 1004 on their respective pre_TBTT. These respective pre_TBTT may be represented by p₂ and p₂₋₁, as described above. Block 1118 may include some or all of the features of blocks 320, 324 described above with respect to FIG. 3.

At block 1120, the processing logic may transmit the AP2 and AP2-1 beacons 204, 1004 on their respective TBTT. Their respective TBTT may be represented by t₂ and t₂₋₁, as described above. Block 1120 may include some or all of the features of block 326 described above with respect to FIG. 3.

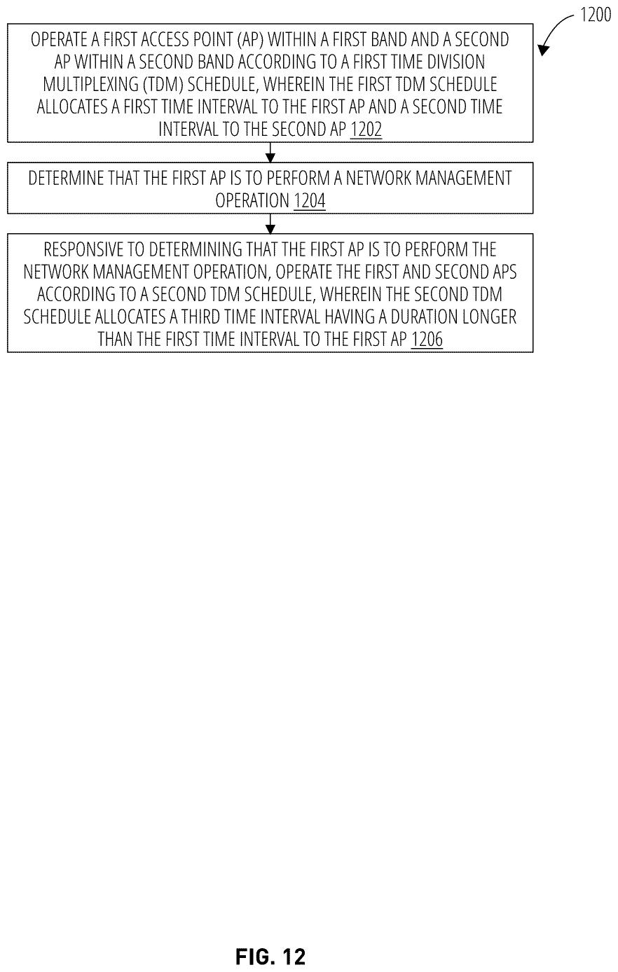

FIG. 12 a flowchart illustrating a method 1200 of modifying time slices (also referred to as time-intervals), according to one embodiment. The method 1200 may be performed by processing logic that may comprise hardware (e.g., circuitry, dedicated logic, programmable logic, microcode, etc.), software (e.g., instructions run on a processing device to perform hardware simulation), firmware, or a combination thereof. In at least one embodiment, the processing logic may refer to one or more portions of a wireless device, such as a MAC layer, a PHY layer (e.g., MAC/PHY core 102), and/or components of one or more RF chains (e.g., first RF chain 104, second RF chain 108). According to embodiments, the processing logic may refer to one or more processing devices of a wireless device. The processing logic may include one or more processing devices and a memory storing instructions that, when executed by the one or more processing devices, perform the method 1200. One or more operations of the method 1200 may be performed by the VSDB logic 112, as described herein. In at least one embodiment, the processing logic includes the VSDB logic 112. The method 1200 can be performed at least partially by other devices described herein.

At block 1202, the processing logic may operate a first access point (AP) within a first band and a second AP within a second band according to a first time division multiplexing (TDM) schedule. The first TDM schedule may allocate a first time-interval to the first AP and a second time-interval to the second AP. In at least some embodiments, the processing logic may operate the first AP based on a hardware timer (e.g., hardware interrupt t₁ described herein) and the second AP based on a software timer (e.g., first software timer t₂ described herein).

At block 1204, the processing logic may determine that the first AP is to perform a network management operation. This network management operation may be any operation for which an active AP may be prioritized, as described herein. The network management operation may include, but is not limited to, WLAN onboarding processes, DHCP onboarding processes, scanning, association, authentication, roaming, handover, channel selection, load balancing, QoS management, or secure key exchanges (e.g., EAPOL key handshake).

In at least one embodiment, the processing logic may determine that the first AP is to perform a first operation that is relatively more critical than a second operation performed by the second AP. The processing logic may make this determination by comparing criticality levels for each of the respective first and second operations. For the processing logic to determine that the operation is “prioritized” or has a higher criticality level than the second operation, the processing logic may have access to a reference point or set of criteria that guides the decision. This reference point or set of criteria may serves as a benchmark or input that the processing logic evaluates to make the prioritization determination. For example, one common reference could be explicit priority or criticality values assigned to different operations, such as numerical rankings or priority levels (e.g., high, medium, or low) that indicate the relative importance of each task. Another example might be time constraints or deadlines, where operations with the most urgent deadlines are prioritized to ensure timely completion. Alternatively, the processing logic might reference resource availability, prioritizing operations that can be executed immediately with the resources currently available, while deferring tasks requiring unavailable resources. Other possibilities include dependency relationships, where tasks that other operations depend on are prioritized to avoid bottlenecks, or system-defined rules or policies, such as those found in network traffic management systems where certain types of traffic (e.g., video streaming) are given priority over others (e.g., bulk file downloads). For example, the first operation may be a network management operation while the second operation includes forwarding data to another device. As another example, the first operation may include forwarding video and/or audio data to a first device, while the second operation includes forwarding a type of data that is less latency sensitive. Here, it may be beneficial to switch from the first TDM schedule to the second TDM schedule (as described below) to provide more active time for the first AP while performing the first operation. However, the second TDM schedule may still provide enough active time for the second AP so as to avoid negatively impacting the second operation.

At block 1206, the processing logic may, responsive to determining that the first AP is to perform the network management operation, operate the first and second APs according to a second TDM schedule. The second TDM schedule may allocate a third time-interval having a duration longer than the first time-interval to the first AP. The third interval may be a majority of a TBTT interval. In other words, the third interval may have a duration of longer than half of a TBTT interval. In some embodiments, the duration of the third time-interval may be based on a duration of the network management operation. The second TDM schedule may allocate a fourth time-interval having a duration shorter than the second time-interval to the second AP.

In some embodiments, once the network management operation is completed, the processing logic may again operate the first and second APs according to the first TDM schedule. In other words, once the network management is completed, the processing logic may revert back to the initial TDM schedule that was used to allocate access to the medium between the active APs.

According to embodiments, the processing logic may operate the first AP within the first band and the second AP within the second band according to the first TDM schedule that allocates the first time-interval to the first AP and the second time-interval to the second AP. Then, the processing logic may determine that the first AP is to perform a first operation and that the second AP is to perform a second operation. The processing logic may then make a determination that a first criticality level of the first operation is higher than a second criticality level of the second operation. Then, based on this determination, the processing logic may switch from operating the first AP and the second AP according to the first TDM schedule to operating the first AP and the second AP according to the second TDM schedule that allocates the third time-interval having a duration longer than the first time-interval to the first AP.

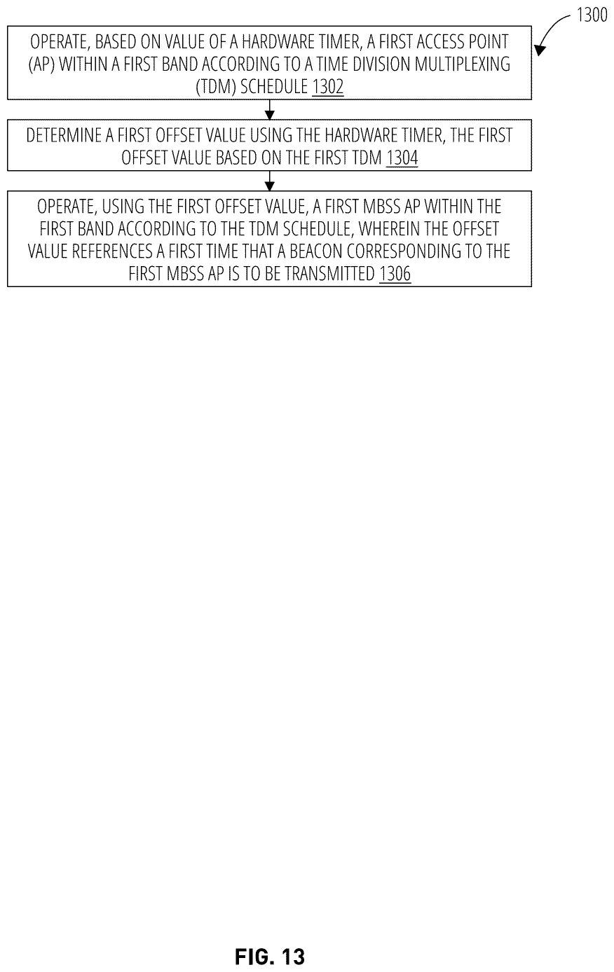

FIG. 13 a flowchart illustrating a method 1300 of operating multiple APs within a same band, according to one embodiment. The method 1300 may be performed by processing logic that may comprise hardware (e.g., circuitry, dedicated logic, programmable logic, microcode, etc.), software (e.g., instructions run on a processing device to perform hardware simulation), firmware, or a combination thereof. In at least one embodiment, the processing logic may refer to one or more portions of a wireless device, such as a MAC layer, a PHY layer (e.g., MAC/PHY core 102), and/or components of one or more RF chains (e.g., first RF chain 104, second RF chain 108). According to embodiments, the processing logic may refer to one or more processing devices of a wireless device. The processing logic may include one or more processing devices and a memory storing instructions that, when executed by the one or more processing devices, perform the method 1300. One or more operations of the method 1300 may be performed by the VSDB logic 112, as described herein. In at least one embodiment, the processing logic includes the VSDB logic 112. The method 1300 can be performed at least partially by other devices described herein.

At block 1302, the processing logic may operate, based on a hardware timer, a first access point (AP) within a first band according to a time division multiplexing (TDM) schedule. This hardware timer may be the HW CF timer as described herein (i.e., of the MAC/PHY core 102).

At block 1304, the processing logic may determine a first software timer using the hardware timer. In some embodiments, this first software timer may be the fourth SW timer t₁₋₁ described herein. The first software timer may be based on the first TDM. The first software timer may emulate a CF timer, as described herein.

At block 1306, the processing logic may operate, using the first software timer, a first MBSS AP (e.g., AP1-1) within the first band using the first software timer (or first offset value) according to the TDM schedule. The first software timer may reference a first time that the wireless device is to transmit a beacon corresponding to the first MBSS AP. According to embodiments, the first AP and the first MBSS AP may each operate within a same time interval (e.g., T1). After beacons have been transmitted within the time interval for both the first AP and the first MBSS AP, the first AP and the first MBSS AP may contend for the medium. The first AP and the first MBSS AP may utilize a fairness algorithm to ensure that each has adequate access to the medium during the time interval.

According to embodiments, the processing logic may also generate a second software timer using the hardware timer. The second software timer may emulate a CF timer, as described herein. The processing logic may also operate a second AP (e.g., AP2) within a second band according to the TDM schedule. This second band may be a different band (e.g., 2.4 Ghz) than the first band (e.g., 5 Ghz). The second software timer may reference a second time that the wireless device is to transmit a beacon corresponding to the second AP.

According to embodiments, the processing logic may also generate a third software timer using the hardware timer. The third software timer may emulate a CF timer, as described herein. The processing logic may also operate a second MBSS AP (e.g., AP2-1) within the second band using the third software timer according to the TDM schedule. The third software timer may reference a third time that the wireless device is to transmit a beacon corresponding to the second MBSS AP. According to embodiments, the second AP and the second MBSS AP may each operate within a same time interval (e.g., T2). After beacons have been transmitted within the time interval for both the second AP and the second MBSS AP, the second AP and the second MBSS AP may contend for the medium. The second AP and the second MBSS AP may utilize a fairness algorithm to ensure that each has adequate access to the medium during the time interval.

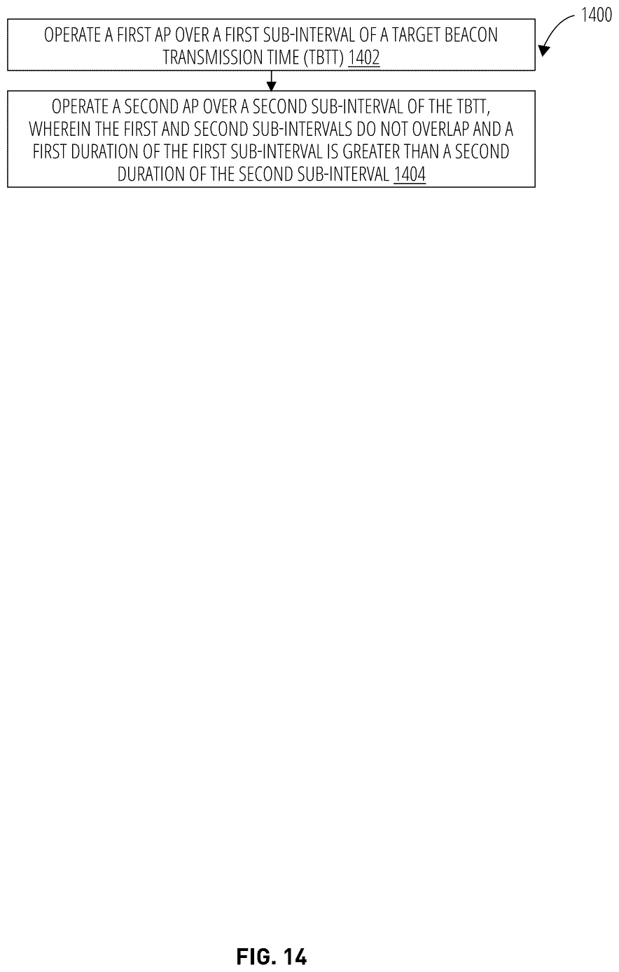

FIG. 14 a flowchart illustrating a method 1400 of operating multiple APs according to an asymmetrical time division multiplexing (TDM) schedule, according to one embodiment. The method 1400 may be performed by processing logic that may comprise hardware (e.g., circuitry, dedicated logic, programmable logic, microcode, etc.), software (e.g., instructions run on a processing device to perform hardware simulation), firmware, or a combination thereof. In at least one embodiment, the processing logic may refer to one or more portions of a wireless device, such as a MAC layer, a PHY layer (e.g., MAC/PHY core 102), and/or components of one or more RF chains (eg., first RF chain 104, second RF chain 108). According to embodiments, the processing logic may refer to one or more processing devices of a wireless device. The processing logic may include one or more processing devices and a memory storing instructions that, when executed by the one or more processing devices, perform the method 1400. One or more operations of the method 1400 may be performed by the VSDB logic 112, as described herein. In at least one embodiment, the processing logic includes the VSDB logic 112. The method 1400 can be performed at least partially by other devices described herein.

At block 1402, the processing logic may operate a first AP over a first sub-interval of a target beacon transmission time (TBTT). This first sub-interval may refer to a first time slice (e.g., T1) corresponding to the first AP, as described herein.

At block 1404, the processing logic may operate a second AP over a second sub-interval of the TBTT. This second sub-interval may refer to a second time slice (e.g., T2) corresponding to the second AP, as described herein. In at least some embodiments, the first and second sub-intervals may not overlap. In some embodiments, a first duration of the first sub-interval may be greater than a second duration of the second sub-interval. In other words, these two sub-intervals may be asymmetrical.

In some embodiments, the first duration may not be greater than a one-third part of the TBTT interval. For example, if the TBTT interval is approximately 102 ms, the first duration may not be greater than approximately 34 ms. In at least one embodiments, the second duration may not be less than a one-sixth part of the TBTT interval. For example, if the TBTT interval is approximately 102 ms, the second duration may not be less than approximately 17 ms.

According to embodiments, the first sub-interval may be initiated based on a hardware timer. For example, a hardware interrupt (i.e., the HW interrupt t₁) may correspond to a transmitting a beacon corresponding to the first AP. The second sub-interval may be initiated based on a software timer (e. g, t₂) that is based on the hardware timer.

In some embodiments, the second sub-interval may immediately follow the first sub-interval. A third sub-interval may immediately follow the second sub-interval. The first AP may be operated over the third sub-interval. A fourth sub-interval may immediately follow the fourth sub-interval. The second AP may be operated over the fourth sub-interval. According to embodiments, this third sub-interval may have either the first duration or a third duration greater than the first duration. The third sub-interval may have the third duration if the processing logic determines that the first AP is to perform a network management operation, and the processing logic prioritizes the first AP over the second AP, as described herein. Similarly, the fourth sub-interval may have either the second duration or a fourth duration less than the second duration. The fourth sub-interval may have the fourth duration if the processing logic prioritizes the first AP over the second AP. In at least one embodiment, the third and fourth sub-intervals may be part of a same TBTT interval as the first and second sub-intervals or may be part of a subsequent TBTT interval.

In the above description, numerous details are set forth. It will be apparent, however, to one of ordinary skill in the art having the benefit of this disclosure, that embodiments of the present disclosure may be practiced without these specific details. In some instances, well-known structures and devices are shown in block diagram form, rather than in detail, in order to avoid obscuring the description. Additionally, in the above description, reference is made to the accompanying figures which form a part hereof, and in which is shown, by way of illustration, several embodiments of the present disclosure. It is understood that other embodiments may be utilized and structural changes may be made without departing from the scope of the present disclosure.

As used herein, the term “approximate” or variations thereof can refer to various ranges. Each particular instance of the term “approximate” may have one or more suitable ranges. These ranges can include, but are not limited to, values up to at least 10% above or below the specified value or timing example. The exact degree of approximation may depend on the context and application, and may encompass any tolerance or deviation that is suitable for achieving the desired function or result in the particular instance.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “receiving,” “adjusting,” or the like, refer to the actions and processes of a computing system, or similar electronic computing device, that manipulates and transforms data represented as physical (e.g., electronic) quantities within the computing system's registers and memories into other data similarly represented as physical quantities within the computing system memories or registers or other such information storage, transmission or display devices.

The words “example” or “exemplary” are used herein to mean serving as an example, instance or illustration. Any aspect or design described herein as “example” or “exemplary” is not necessarily to be construed as preferred or advantageous over other aspects or designs. Rather, the use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “some embodiments” throughout is not intended to mean the same embodiment or embodiments unless described as such.

Embodiments described herein may also relate to an apparatus for performing the operations herein. This apparatus may be specially constructed for the required purposes, or it may comprise a general-purpose computer selectively activated or reconfigured by a computer program stored in the computer. Such a computer program may be stored in a non-transitory computer-readable storage medium, such as, but not limited to, any type of disk including floppy disks, optical disks, CD-ROMs and magnetic-optical disks, read-only memories (ROMs), random access memories (RAMs), EPROMs, EEPROMs, magnetic or optical cards, flash memory, or any type of media suitable for storing electronic instructions. The term “computer-readable storage medium” should be taken to include a single medium or multiple media (e.g., a centralized or distributed database and/or associated caches and servers) that store one or more sets of instructions. The term “computer-readable medium” shall also be taken to include any medium capable of storing, encoding, or carrying a set of instructions for execution by the machine and that causes the machine to perform any one or more of the methodologies of the present embodiments. The term “computer-readable storage medium” shall accordingly be taken to include, but not be limited to, solid-state memories, optical media, magnetic media, and any medium that is capable of storing a set of instructions for execution by the machine and that causes the machine to perform any one or more of the methodologies of the present embodiments.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present embodiments are not described with reference to any particular programming language. It will be appreciated that a variety of programming languages may be used to implement the teachings of the embodiments as described herein.

The above description sets forth numerous specific details, such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or presented in simple block diagram format to avoid unnecessarily obscuring the present disclosure. Thus, the specific details set forth above are merely exemplary. Particular embodiments may vary from these exemplary details and still be contemplated to be within the scope of the present disclosure.

It is to be understood that the above description is intended to be illustrative and not restrictive. Many other embodiments will be apparent to those of skill in the art upon reading and understanding the above description. The scope of the disclosure should, therefore, be determined with reference to the appended claims, along with the full scope of equivalents to which such claims are entitled.

In the above description, for purposes of explanation, numerous specific details are set forth in order to provide a thorough understanding of the present disclosure. It will be evident, however, to one skilled in the art that the present disclosure may be practiced without these specific details. In other instances, well-known circuits, structures, and techniques are not shown in detail, but rather in a block diagram in order to avoid unnecessarily obscuring an understanding of this description.

Reference in the description to “one embodiment,” “an embodiment,” or “some embodiments” means that a particular feature, structure, or characteristic described in connection with the embodiment(s) is included in at least one embodiment of the disclosure. The phrase “in one embodiment” or “in some embodiments” located in various places in this description does not necessarily refer to the same embodiment(s).

What is claimed is:

1. A wireless device comprising:
a single media access control (MAC) and physical layer (PHY) core;
one or more processing devices; and
memory storing instructions that, when executed by the one or more processing devices, cause the wireless device to:
operate a first access point (AP) within a first band and a second AP within a second band according to a first time division multiplexing (TDM) schedule, wherein the first TDM schedule allocates a first time-interval to the first AP and a second time-interval to the second AP;
determine that the first AP is to perform a first operation and that the second AP is to perform a second operation; and
based on a determination that a first criticality level of the first operation is higher than a second criticality level of the second operation, switch from operating the first AP and the second AP according to the first TDM schedule to operating the first AP and the second AP according to a second TDM schedule, wherein the second TDM schedule allocates a third time-interval having a duration longer than the first time-interval to the first AP.

2. The wireless device of claim 1, wherein the second TDM schedule allocates a fourth time-interval having a duration shorter than the second time-interval to the second AP.

3. The wireless device of claim 1, wherein the duration of the third time-interval is based on a duration of the first operation.

4. The wireless device of claim 1, wherein the instructions further cause the wireless device to:
after the first operation has completed, operate the first and second APs according to the first TDM schedule.

5. The wireless device of claim 1, wherein the first operation is a wireless local area network (WLAN) onboarding process.

6. The wireless device of claim 1, wherein to determine that the first AP is to perform the first operation, the instructions cause the wireless device to:
receive, from a client device, a request to connect to the first AP.

7. The wireless device of claim 1, wherein the first operation is a dynamic host configuration protocol (DHCP) discovery process.

8. The wireless device of claim 1, wherein the first and second time-intervals are asymmetric.

9. The wireless device of claim 1, wherein to operate the first and second APs according to the first TDM schedule, the instructions cause the wireless device to:
operate the first AP according to the first TDM using a hardware timer;
generate a first software timer using the hardware timer and a first offset value; and
operate the second AP according to the first TDM using the software timer.

10. The wireless device of claim 9, wherein to operate the first and second APs according to the second TDM schedule, the instructions cause the wireless device to:
operating the first AP according to the second TDM using the hardware timer;
generating a second software timer using the hardware timer and a second offset value different from the first offset value; and
operating the second AP according to the second TDM using the software timer.

11. The wireless device of claim 1, wherein the third time-interval is a majority of a target beacon transmission time (TBTT) interval.

12. A method of operating a wireless device with a single media access control (MAC) layer, the method comprising:
operating, based on a hardware timer, a first access point (AP) within a first band according to a time division multiplexing (TDM) schedule;
determining a first software timer using the hardware timer, the first software timer based on the TDM schedule; and
operating, using the first software timer, a second AP within the first band according to the TDM schedule, wherein the first software timer references a first time that the wireless device is to transmit a beacon corresponding to the second AP.

13. The method of claim 12, further comprising:
generating a second software timer using the hardware timer; and
operating, using the second software timer, a third AP within a second band according to the TDM schedule, wherein the second software timer references a second time that the wireless device is to transmit a beacon corresponding to the third AP.

14. The method of claim 13, further comprising:
generating a third software timer using the hardware timer; and
operating, using the third software timer, a fourth AP within the second band according to the TDM schedule, wherein the third software timer references a third time that the wireless device is to transmit a beacon corresponding to the fourth AP.

15. A method of operating a wireless device with a single media access control (MAC) layer, the method comprising:
operating a first AP over a first sub-interval of a target beacon transmission time (TBTT) interval; and
operating a second AP over a second sub-interval of the TBTT, wherein the first and second sub-intervals do not overlap and a first duration of the first sub-interval is greater than a second duration of the second sub-interval.

16. The method of claim 15, wherein the first duration is not greater than a one-third part of the TBTT interval.

17. The method of claim 15, wherein the second duration is not less than a one-sixth part of the TBTT interval.

18. The method of claim 15, wherein the first sub-interval is initiated based on a hardware timer, and wherein the second sub-interval is initiated based on a software timer based on the hardware timer.

19. The method of claim 15, wherein the second sub-interval immediately follows the first sub-interval, and wherein the method further comprises:
operating, immediately following the second sub-interval, the first AP over a third sub-interval of the TBTT interval, the third sub-interval having the first duration; and
operating, immediately following the third interval, the second AP over a fourth sub-interval of the TBTT interval, the fourth sub-interval having the second duration.

20. The method of claim 15, wherein the method further comprises:
determining that the first AP is to perform a network management operation;
operating the first AP over a third sub-interval of a subsequent TBTT, the third sub-interval having a third duration greater than the first duration; and
operating the second AP over a fourth sub-interval of the subsequent TBTT, the fourth sub-interval having a fourth duration less than the first duration.
